(19) United States
(12) Patent Application Publication
(10) Pub. No.: US 2005/0026096 A1
(43) Pub. Date: Feb. 3, 2005

(54) Streamlined body and combustion apparatus having such a streamlined body

(76) Inventors: Franz Josef Staffler, Bozen (IT); Vincenzo Branzi, Terzolas (IT)

Correspondence Address: David E. Bruhn, Esq.;DORSEY & WHITNEY LLP, Intellectual Property Department, 50 South Sixth Street, Suite 1500, Minneapolis, MN, 55402-1498, US

(21) Appl. No.: 10/851,904

(22) Filed: May 21, 2004

Related U.S. Application Data
(63) Continuation of application No. PCT/EP02/13243, filed on Nov. 25, 2002.

(30) Foreign Application Priority Data
Nov. 23, 2001 (DE) 101 58 295.1

(51) Int. Cl. F23M 3/02; F23C 5/00; G01F 15/00

(52) U.S. Cl. 431/8

(57) ABSTRACT

A streamlined body for influencing the flow dynamics of a fluid, wherein the streamlined body at least partly corresponds to a symmetrically rotated airfoil. A streamlined body of this kind can be used in a number of ways, for example, as an impact member, as a flow regulator or as a heat exchanger. It also evens out and accelerates flows. It is used to particular advantage in a mixing and reaction chamber for burning fuels.

### CROSS-REFERENCE TO RELATED APPLICATION(S)

This application is a continuation of International Patent Application No. PCT/EP02/13243, filed on Nov. 25, 2002, which claims priority to German Patent Application No. 101 58 295.1, filed on Nov. 23, 2001, the contents of both applications are incorporated by reference in their entirety.

### BACKGROUND OF THE INVENTION

The invention relates to a streamlined body for influencing the dynamics of a flow and to characteristics, uses and effects of the streamlined body. The invention further relates to an apparatus for burning a fuel mixture comprising such a streamlined body and uses of this apparatus.

Flow bodies or baffle members are used in various technical fields for deflecting flows or influencing their dynamics. In combustion technology, for example, it is known to improve the distribution of a fuel mixture which is to be burned inside a reaction chamber by placing a deflector surface in the direction of flow of the mixture. A deflector surface of this kind is used in WO99/24756 to deflect the mixture which is to be burned out of its original direction of influx and distribute it as symmetrically as possible inside the reaction chamber, thereby promoting mixing of the individual components of the fuel mixture and thus achieving fast and total combustion thereof. The specification proposes as the deflector surface conical or pyramidal surfaces the apex of which points in the direction of the inflowing mixture.

One disadvantage of a deflector surface of this kind is that because of the deceleration of the components of the fuel mixture associated with the deflection and because of the partial reflection of these components back in the direction of the inflow openings, it is not possible to achieve the desired homogenous flow of the combustible mixture accelerating in the direction of the outlet opening of the reaction chamber.

DE 21 53 817 OS discloses a burner for burning waste materials wherein the waste materials together with air supplied step by step enter a combustion chamber in which there is a so-called hot bulb. This hot bulb is conical in shape and is arranged with its tip pointing in the direction of the inflowing mixture which is to be burned and coaxially with the axis of the combustion chamber. This hot bulb is at a temperature of 1200 to 1400° C. and causes combustion of unburnt components of the waste material such as, for example, solid particles which are difficult to burn. This hot bulb may also be in the form of a ring.

A hot bulb of the kind according to DE 21 53 817 OS has a negative effect on the flow dynamics in the combustion chamber for the reasons mentioned above.

Starting from this set of problems, the present invention sets out to provide a streamlined body which generally has a positive influence on the dynamics of a flow for various applications and in particular makes it possible to even out the flow and control the flow velocity. The streamlined body is particularly intended for use in the combustion of a fuel mixture.

According to the invention, the outer surface of the streamlined body at least partially corresponds to a symmetrically rotated airfoil. For the purposes of the present description, the term airfoil means a body designed to provide a desired reaction when there is relative motion between it and a flow, and, more particularly, a profile which substantially corresponds to the top surface of the cross-section of an aeroplane wing. A symmetrically rotated airfoil can thus be produced by rotating an aeroplane wing profile about its chord. The streamlined body according to the invention may then correspond wholly or at least partially to a symmetrically rotated airfoil of this kind. It may be advantageous to make the streamlined body variable in its geometry. For this purpose the streamlined body may be made up of several parts which are exchangeable in order to adapt geometric parameters such as diameter or length to changing situations. It is also conceivable to construct a flow body which is dynamically variable in its geometry.

In a totally rotationally symmetrical streamlined body according to the invention, with a fluid flowing in parallel to the rotation axis, the flow times along the surface of the streamlined body are equal. In an airfoil there are two stagnation points, the front stagnation point being at the blunt end and the rear stagnation point being at the pointed rear end of the profile. It is advantageous to arrange the streamlined body in the flow in such a way that the rear stagnation point is in the downstream position.

In an arrangement of this kind the flow velocity increases during flow from the front to the rear stagnation point compared with the flow velocity without a streamlined body. Any lift forces occurring, as are known with airfoil profiles, cancel each other out thanks to the symmetry of the arrangement.

Moreover, the above-mentioned rotationally symmetrical streamlined body according to the invention may be used to produce laminar flow. Because of the rotational symmetry the fluid particles proceeding from the front stagnation point reach the rear stagnation point at the pointed rear edge of the profile at the same time, so that laminar flow is obtained. At the same time the flow velocity is increased over that which is obtained without a streamlined body as there is a decrease in pressure on the top surface (suction side) of an airfoil.

The increase in flow velocity achieved by the introduction of the streamlined body according to the present invention can be used to generate a suction effect in order to accelerate a fluid and/or particles carried by a fluid in the direction of flow and/or to entrain the fluid and/or particles into the flow (by sucking them in). For example, feed openings for solid particles which are automatically sucked into the flow by the suction effect mentioned above may be provided upstream.

Another use of a rotationally symmetrical streamlined body according to the invention is its use as an impact surface, particularly in a flowing fluid carrying solid and/or liquid particles.

The term fluid denotes a gaseous or liquid medium or a mixture of a gaseous and liquid medium. Fluids of this kind may carry with them particles in the state of a solid or liquid aggregate. Fuel mixtures, for example, frequently consist of a combustible fluid which contains highly viscous (liquid) or solid constituents which are difficult to burn. Combustible gases which carry atomised liquid and/or solid particles are also used as a fuel mixture.

When a fluid carrying solid and/or liquid particles meets a rotationally symmetrical streamlined body according to the present invention, the particles are deflected depending on the speed of flow and impact. This can be used to atomise and break up droplets of liquid or highly viscous particles carried in the fluid or to break up solid particles. However, it is also possible to use this effect for separation. For example, particles deflected in the radial direction may adhere to a wall (or the like) and thus be separated from the rest of the fluid current.

The streamlined body according to the invention may also be used as a heat exchanger. If there is a temperature gradient in a flow, the introduction of a streamlined body according to the present invention consisting of a material that conducts heat into this streamlined body (or on its surface) will start a flow of heat, the heat flowing from the warm part of the streamlined body to the cold part.

If, for example, in a combustion process a flame is produced in a section behind the rear stagnation point of the streamlined body according to the invention, the streamlined body heats up during the combustion process from the rear stagnation point towards the front stagnation point. As a result, the fuel mixture hitting the front stagnation point is preheated. Further advantages are obtained by using a streamlined body according to the invention in a combustion process as described hereinafter.

Another possible use of the streamlined body described is as a flow regulator. Flow regulators regulate the quantity of flow and the speed of flow of a fluid by constricting the area of flow of the fluid. In conventional valves this is done by means of a valve body incorporated in the flow area. However, the constriction frequently results in swirls at the valve body so that it is difficult to measure and control the quantity or speed of flow precisely. Moreover, in numerous applications, a laminar flow after the valve is desirable.

A rotationally symmetrical streamlined body according to the present invention can be used like a valve body in a flow regulator, being arranged with its rotation axis parallel to the direction of flow and with its sharp rear edge downstream in front of a valve outlet line of reduced cross-section. The diameter of the streamlined body is selected so as to suit the diameters of the lines. By moving the streamlined body according to the present invention in the direction of flow the cross-section of the valve outlet line can be covered in a variable manner thereby controlling the quantity and velocity of fluid flowing into the outlet line. To close off the line, the streamlined body is pushed along until it makes contact with the valve outlet line. The flow going past the streamlined body according to the invention is laminar and allows satisfactory measurement of the flow quantity and optimum adjustment of the flow velocity.

One application in which the above qualities of the streamlined body according to the present invention can be used to their full extent is its use in a combustion process in which a fuel mixture flowing through a mixing and reaction chamber is combusted, the streamlined body according to the invention being arranged with its main axis inside the chamber in the direction of flow.

For optimum function, in one embodiment, the blunt section is used as the front stagnation point and the sharp rear edge of the profile is used as the rear stagnation point of the streamlined body. On the one hand, it is possible to use a rotationally symmetrical flow body the rotation axis of which runs parallel to the main axis of the mixing and reaction chamber or is located thereon. However, it is also possible to use two or more halves or pieces of such a streamlined body (with the separation surface or edge roughly running along the rotation axis) and to mount the halves of the streamlined body on the wall of the chamber, distributed around its circumference.

When the streamlined body is used in this way the following favourable effects are achieved:
1) The fuel mixture, which may contain liquid, gaseous and solid constituents, is deflected as it strikes the streamlined body, thereby promoting the mixing of the individual components which are to be burned. Liquid constituents atomise on impact, while solid ones are broken up. This initially produces turbulence in the front part of the streamlined body. Overall, this can increase the residence time of the fuel components and promote their mixing in the chamber.
2) At the same time, the flow is evened out downstream along the streamlined body. The mixture is accelerated in the region of the streamlined body, the velocity vectors in the vicinity of the streamlined body extending parallel thereto, and their magnitude increasing initially as the radial spacing increases, in order to decrease again towards the outer boundaries (e.g., the wall of the chamber). Overall, after flowing round the streamlined body, a laminar flow is obtained. At an outlet opening of the mixing and reaction chamber, the fuel mixture is ignited and a flame appears close to the outlet opening. There should be no reflux of the fuel mixture or combustion products counter to the direction of the outlet opening, in order to prevent blowback of the flame, in particular. The streamlined body according to the invention accelerates the flow of the fuel mixture towards the outlet opening so that the combustion products leave the chamber through the outlet opening at a high velocity (approaching or above the speed of sound), resulting in a suction effect which assists the feeding of the components of the fuel mixture into the chamber.
3) Finally, when used in this way, the streamlined body according to the invention acts as a heat exchanger as the streamlined body heats up towards the front stagnation point starting from the rear stagnation point which is closest to the combustion flame. In permanent operation, the streamlined body can consequently be used as a heat exchanger which preheats the incoming components of the fuel mixture. This assists the atomising and evaporation of liquid components, the breakup and sublimation of solid components and, overall, the preheating of the fuel mixture, thereby particularly reducing the viscosity of highly viscous components which are difficult to burn. As a result of this effect, the speed of combustion is increased and complete combustion of even those components which do not burn easily in the mixture is assisted. This significantly increases the performance of the burner (heat output) so that more fuel can be burnt in the same period of time.

Ideally, in one embodiment, a rotationally symmetrical streamlined body is arranged with its rotation axis along the axis of the reaction chamber, the rear stagnation point (sharp rear edge of the profile) being directed towards the outlet opening of the chamber. It is advantageous to arrange it close to the outlet opening, while the constriction produced in the region of the outlet opening can be adjusted by altering the position of the streamlined body so that the latter additionally acts as a flow regulator.

The streamlined body may, for example, be held by the (cylindrical) wall of the chamber by means of thin retaining strips. A sectional construction is also advantageous so that individual components of the streamlined body can be exchanged or adjusted in order to optimise the combustion process. For example, the streamlined body may be subdivided into a front, middle and back section, while the geometric parameters can be varied by exchanging these sections. In order to measure the parameters of the combustion process and the properties of the streamlined body itself, sensors and measuring lines can be introduced onto or into the streamlined body from outside by means of the above mentioned retaining strips. This gives easy access to the interior of the mixing and reaction chamber.

The advantages described above can be achieved with an apparatus according to the invention for burning a fuel mixture, which comprises a mixing and reaction chamber, and a streamlined body arranged with its main axis within the chamber in the direction of flow. Basically, the shape of the mixing and reaction chamber can be freely selected, e.g., it may be of a simple cylindrical shape.

It is advantageous if the above mentioned combustion apparatus comprises a mixing and reaction chamber which tapers downstream to widen out again in cross section subsequently so that a neck constitutes the point with the smallest cross section. The streamlined body is conveniently arranged in front of the neck in the direction of flow in a geometric configuration of this kind. It has proved particularly advantageous to have a geometric shape in which the mixing and reaction chamber has a cylindrical lower section, adjacent to which is a conically tapering section, while adjoining the neck thus formed is a head of hyperboloid-like shape with a widening cross section which itself ends in an outlet opening. Together with the streamlined body arranged in the mixing or reaction chamber, an apparatus of this kind can be used to achieve optimum regulation of all the combustion parameters as required in particular for burning fuels of different compositions, particularly with highly viscous components.

The apparatus described are suitable for use as burners, i.e., for heating a volume provided downstream thereof, or for use as a propulsive unit, i.e., for producing thrust.

The invention will now be explained in more detail with reference to the exemplary embodiments illustrated in the drawings.

### BRIEF DESCRIPTION OF THE DRAWINGS

FIG. 1 shows the streamlined body according to the invention with a rotationally symmetrical shape.

FIG. 2 shows the airfoil which is the basis for the geometry of the streamlined body according to the invention.

FIG. 3 shows a possible use of the streamlined body according to the invention in a combustion process in a mixing and reaction chamber.

FIG. 4 shows the trajectories of a fluid current in the mixing and reaction chamber shown in FIG. 3 during the combustion process.

FIG. 5 shows a view similar to FIG. 4.

FIG. 6 shows the Mach numbers in the neck of the mixing and reaction chamber from FIGS. 4 and 5.

FIG. 7 shows the velocity vectors in the upper part of a mixing and reaction chamber as shown in FIGS. 4 and 5.

FIG. 8 shows a view according to FIG. 7 with a higher resolution.

### DETAILED DESCRIPTION

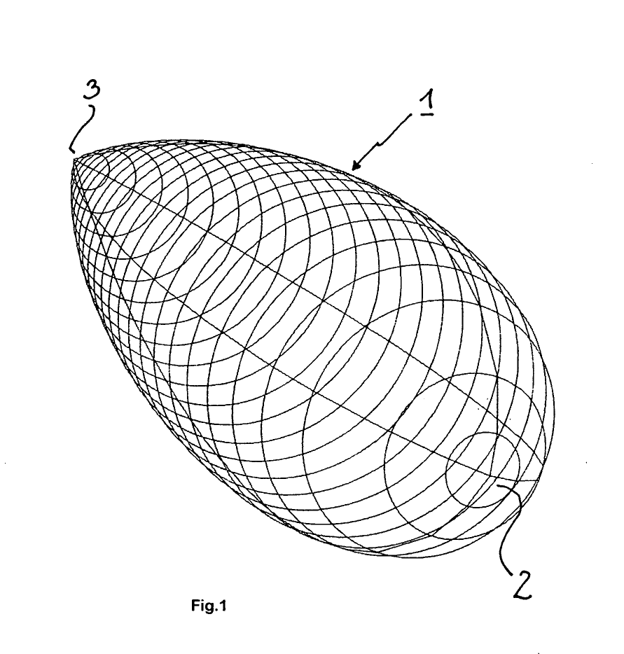

FIG. 1 shows in three-dimensional view a streamlined body 1 according to the invention with its two stagnation points 2 and 3. The streamlined body 1 is rotationally symmetrical in shape and, in this example, substantially corresponds to a symmetrically rotated airfoil. From the fluidics point of view a favourable arrangement is one in which the stagnation point 2 is used as the front stagnation point and stagnation point 3 is used as the rear stagnation point, i.e., the flow runs from the front stagnation point 2 to the rear stagnation point 3.

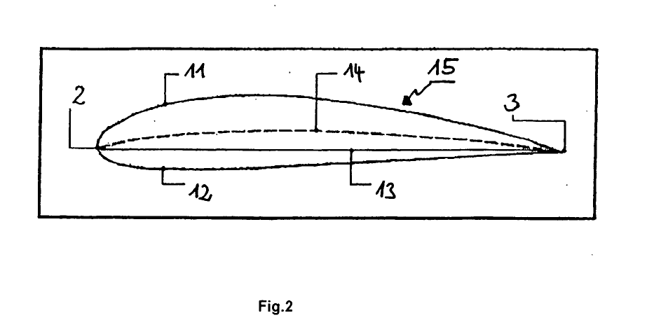

FIG. 2 shows an example of an airfoil 15 with a top surface side 11 and an underside 12, a front stagnation point 2 and a rear stagnation point 3 as well as a profile chord 13 and a central line 14. When an airfoil 15 of this kind is rotated about the profile chord 13 the surface of a streamlined body 1 according to the invention is produced, as shown in FIG. 1, for example. As can be seen from FIG. 2, when the airfoil is rotated, only the top surface 11 is important because of the geometry, so that the rotationally symmetrical streamlined body can also be produced by rotating the top surface side 11 of the airfoil (or a cross section of an aeroplane wing) about the profile chord 13.

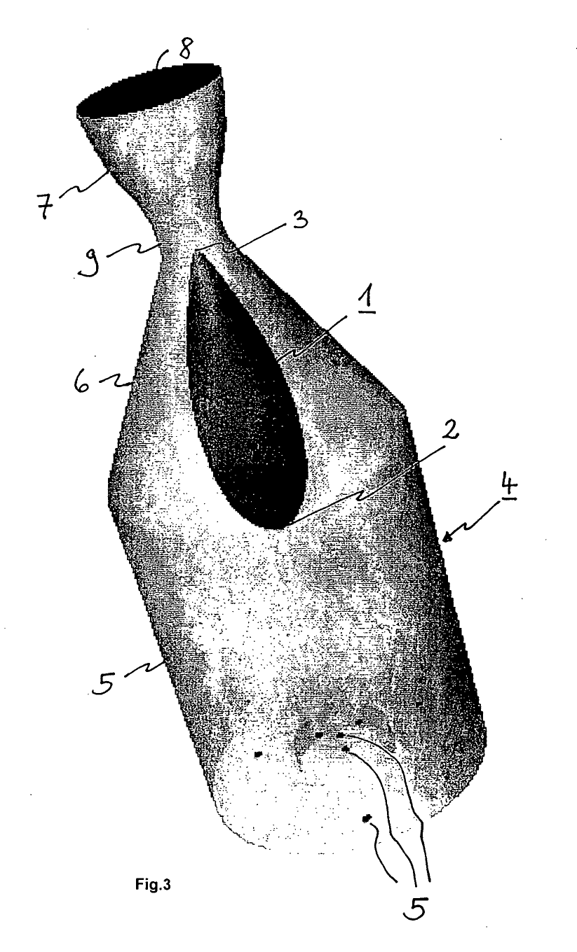

FIG. 3 shows an advantageous embodiment of an apparatus according to the invention for burning fuels with a streamlined body 1 as described above. This Figure shows a mixing and reaction chamber 4 the lower section 5 of which is cylindrical in shape and which initially tapers conically upwards in section 6. The cross section of the chamber is at its smallest in the neck 9 and from that point onwards increases in size again in the head 7. The head 7 of the chamber is hyperboloidlike in form. The outlet opening of the chamber is designated 8. In the base of the chamber 4 are supply lines 5 for the constituents of the mixture which is to be burnt, such as for example gaseous and or liquid and/or solid fuel, air and/or an additional or different oxidant and possibly water or other additives.

The embodiment of the combustion device shown here is used particularly as a burner with a variety of industrial applications (heating furnaces, melting materials such as metals or glass, evaporating water or other liquids). Another possible use for the apparatus according to the invention is as a propulsion unit for generating thrust. For this, a similar embodiment to the one shown in FIG. 3 may be used, except that the base of the chamber 4 must be wholly or partly removed to allow flow through the interior of the apparatus. One possibility here is to use it as a propulsion unit in a fluid such as air or particularly water.

The ingredients of the fuel mixture are initially carried into the interior of the chamber 4 under pressure and ignited inside the chamber 4. For details of the combustion process reference is hereby expressly made to WO99/24756 by the same applicant.

Because of the flow conditions in the mixing and reaction chamber 4, the actual combustion flame is formed in the vicinity of the outlet opening 8. The flow conditions inside the chamber must be designed so that the flame is prevented from breaking off on the one hand and from blowing back into the interior of the chamber on the other hand. An ideal instrument for regulating and controlling the flow conditions inside the chamber 4 is the streamlined body 1 according to the invention. It can be fixedly or moveably secured by retaining and/or guide strips inside the chamber 4, while it is particularly advantageous for it to be moveable along the main axis of the chamber in the direction of the neck 9.

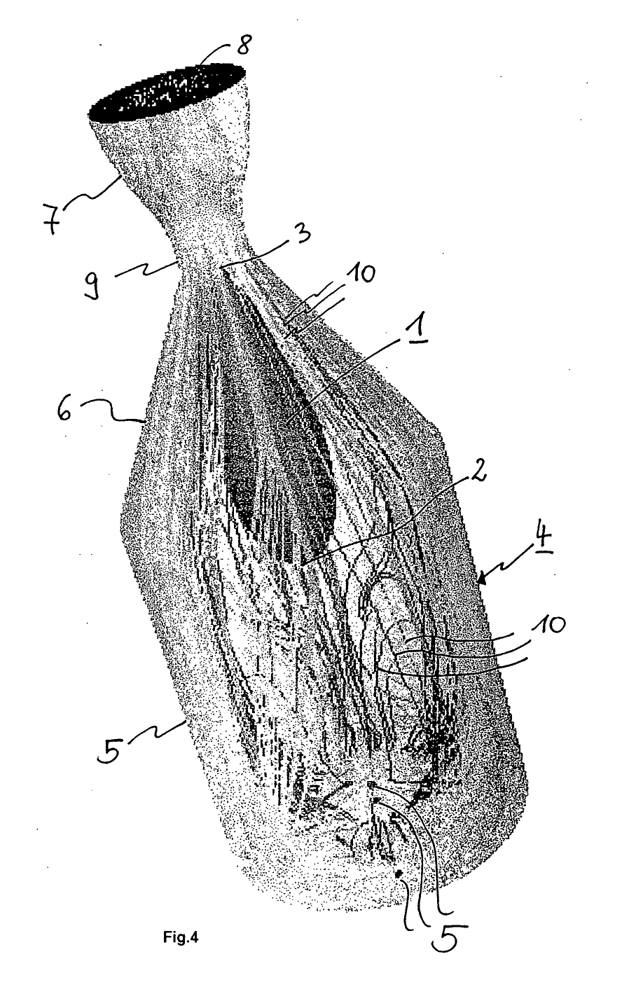

FIG. 4 shows the stream of particles formed during the operation of the mixing and reaction chamber 4. The trajectories 10 clearly show that in the lower cylindrical section 5 of the chamber 4 turbulence occurs, in which individual trajectories describe a path back towards the bottom of the chamber 4. This turbulence is beneficial to the combustion process as it results in more intensive mixing and a longer residence time of the components of the fuel mixture in the chamber 4, thereby assisting complete combustion.

Further along, i.e., towards the tapering section 6 of the chamber, FIG. 4 clearly shows a more ordered flow which becomes laminar along the streamlined body 1 according to the invention, while the profile of the streamlined body 1 according to the invention continues, so to speak, in the direction of flow.

At the rear stagnation point 3 of the streamlined body 1, which is disposed virtually in the neck 9 of the chamber 4 in the embodiment shown in FIG. 4, there is a totally uniform flow leaving the chamber 4 via the head 7 of the chamber through the outlet opening 8. A flame (not shown) burns steadily at this point.

It should be pointed out that FIG. 4 shows the flow pattern of a fluid and/or particles carried along by a fluid by means of trajectories of model particles illustrated by way of example.

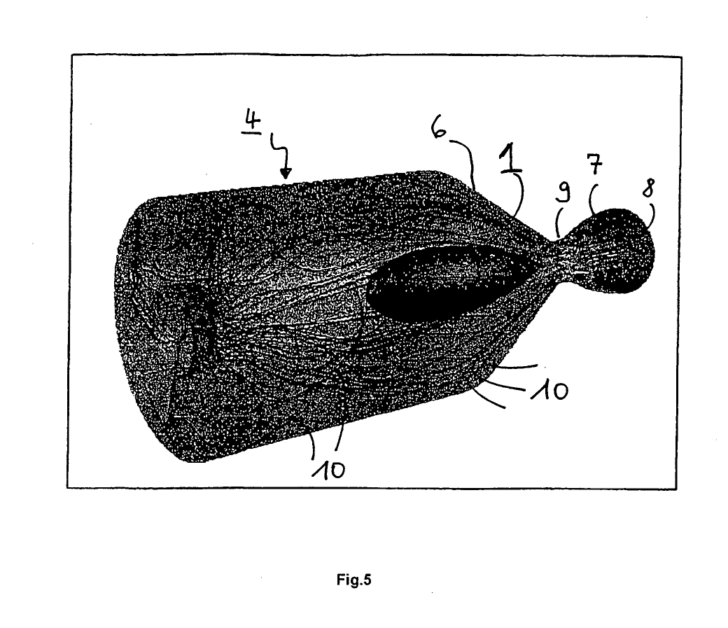

A similar view to that of FIG. 4 is provided in FIG. 5, for which a different three-dimensional view is used. The remarks made in connection with FIG. 4 discussed above also apply here. Similar parts have been given the same reference numerals.

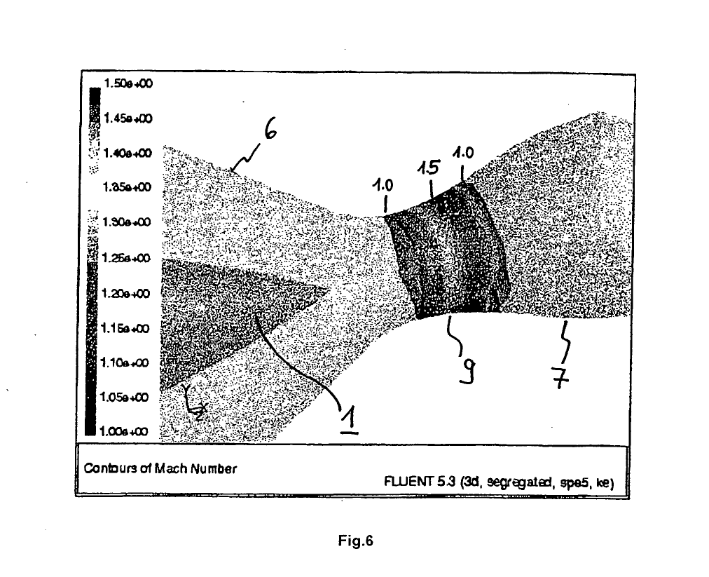

FIG. 6 now shows the upper section of a mixing and reaction chamber 4 as shown in FIGS. 4 and 5, showing the conditions of speed distribution in the neck 9 of the chamber 4. The distribution of the Mach numbers in the neck 9 and in the head 7 of the chamber 4 are shown during a combustion process. The temperatures in this example are about 1300° C. The Mach numbers, i.e. multiples of the speed of sound, are shown in different shades of grey. The grey shading means that the original colour information is lost and has to be replaced by a description in words: the Figure clearly shows the darker sleeve around the neck 9 of the chamber 4, indicating areas in which the mixture flowing out has exceeded the speed of sound. The bar on the left of the Figure indicates the values occurring which are between 1.0 and 1.5 times the speed of sound. Values below the speed of sound are shown by the even grey colour in FIG. 6. The streamlined body 1 positioned close to the neck 9 is clearly shown. The distribution of the Mach numbers is now as follows: beginning with Mach 1.0 at the bottom dark edge of the sleeve, the Mach number rises continuously to 1.5, and the grey coloration thus corresponds precisely to the bar shown on the left-hand edge of the Figure. The value 1.5 is again indicated by a dark section. Then the Mach number decreases again to 1.0, this reduction occurring within a shorter section of the sleeve, so that here again we have the reverse distribution of the bar shown in the left-hand edge of the Figure.

Supersonic speed is reached, as described, by the interaction of the streamlined body 1 according to the invention with the geometry of the chamber 4. The head 7 and neck 9 of the chamber are hyperboloid-like in shape and adjoin the tapering section 6 so that this very geometry causes a sharp acceleration of flow towards the outlet opening 8. This is further increased by the streamlined body 1 according to the present invention, on the surface of which there is a reduction in pressure leading to an increase in flow velocity.

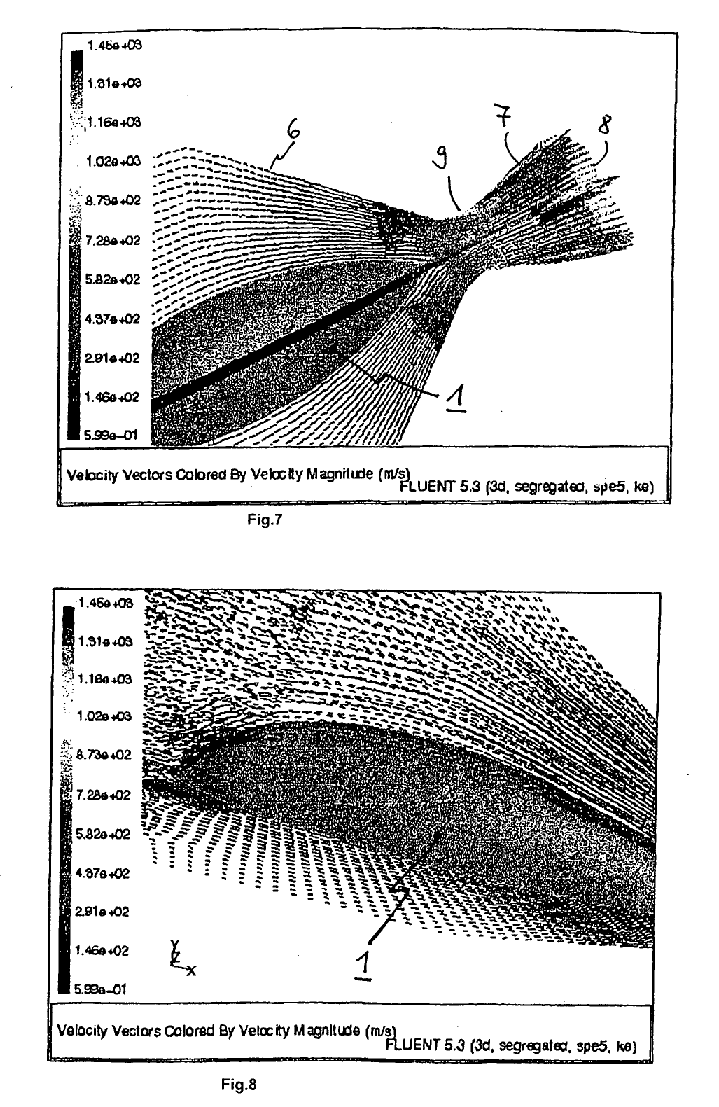

FIGS. 7 and 8 show the distribution of the speed vectors in the upper part of the mixing and reaction chamber and on the streamlined body 1 during a combustion process, while FIG. 8 shows a detail on a larger scale in which the streamlined body is not shown in its fully rotationally symmetrical form but is cut away at an angle of 120°.

It is clear how the profile of the streamlined body 1 continues in the flow, extending fully uniformly between the streamlined body 1 and the wall of the chamber 4 towards the neck 9.

Suitable materials for the streamlined body 1 according to the invention might be, for example, an (ODS) Ni alloy or ceramic alloy or a ceramic coating, particularly for use in a combustion process.

In the foregoing description embodiments of the invention, including preferred embodiments, have been presented for the purpose of illustration and description. They are not intended to be exhaustive or to limit the invention to the precise form or steps disclosed. Obvious modifications or variations are possible in light of the above teachings. The embodiments were chosen and described to provide the best illustration of the principals of the invention and its practical application, and to enable one of ordinary skill in the art to utilize the invention in various embodiments and with various modifications as are suited to the particular use contemplated. All such modifications and variations are within the scope of the invention as determined by the appended claims when interpreted in accordance with the breadth they are fairly, legally, and equitably entitled.

1. A streamlined body for use in a combustion process wherein a fuel mixture flowing in a mixing and reaction chamber is combusted, the streamlined body having a main axis and being arranged with its main axis inside the chamber in the direction of flow, where
in an outer surface of the streamlined body is generated by rotating a top surface side of an aeroplane wing profile about its profile chord.

2. The streamlined body according to claim 1, wherein the streamlined body is variable in its geometry.

3. The streamlined body according to claim 1, wherein the streamlined body produces a laminar flow.

4. The streamlined body according to claim 2, wherein the streamlined body produces a laminar flow.

5. The streamlined body according to claim 1, wherein the streamlined body is placed with its main axis in the direction of flow in an otherwise free cross section of flow in order to produce a suction effect in the direction of flow.

6. The streamlined body according to claim 2, wherein the streamlined body is placed with its main axis in the direction of flow in an otherwise free cross section of flow in order to produce a suction effect in the direction of flow.

7. The streamlined body according to claim 1, wherein at least a portion of the streamlined body is heat conductive and wherein the streamlined body is used as a heat exchanger by placing it in a flow with a temperature gradient.

8. The streamlined body according to claim 2, wherein at least a portion of the streamlined body is heat conductive and wherein the streamlined body is used as a heat exchanger by placing it in a flow with a temperature gradient.

9. The streamlined body according to claim 1, wherein the streamlined body has a rear stagnation point and the rear stagnation point is arranged downstream.

10. The streamlined body according to claim 2, wherein the streamlined body has a rear stagnation point and the rear stagnation point is arranged downstream.

11. The streamlined body according to claim 1, wherein the streamlined body acts as an impact surface for the inflowing fuel mixture.

12. The streamlined body according to claim 2, wherein the streamlined body acts as an impact surface for the inflowing fuel mixture.

13. The streamlined body according to claim 10, wherein the streamlined body acts as an impact surface for the inflowing fuel mixture.

14. The streamlined body according to claim 11, wherein the streamlined body provides at least one of separation, distribution, atomisation and comminution of the fuel mixture, wherein the fuel mixture comprises at least one of gaseous, liquid and solid constituents.

15. The streamlined body according to claim 11, wherein the streamlined body provides for slowing down constituents of the fuel mixture, for increasing the residence time of the constituents and for mixing the constituents more thoroughly.

16. The streamlined body according to claim 14, wherein the streamlined body provides for slowing down the constituents of the fuel mixture, for increasing the residence time of these constituents and for mixing these constituents more thoroughly.

17. The streamlined body according to claim 1, wherein the combustion produces combustion products, and the streamlined body accelerates the flow of the fuel mixture and the combustion products in the mixing and reaction chamber towards an outlet opening of the mixing and reaction chamber.

18. The streamlined body according to claim 2, wherein the combustion produces combustion products, and the streamlined body accelerates the flow of the fuel mixture and the combustion products in the mixing and reaction chamber towards an outlet opening of the mixing and reaction chamber.

19. The streamlined body according to claim 10, wherein the combustion produces combustion products, and the streamlined body accelerates the flow of the fuel mixture and the combustion products in the mixing and reaction chamber towards an outlet opening of this chamber.

20. The streamlined body according to claim 11, wherein the combustion produces combustion products, and the streamlined body accelerates the flow of the fuel mixture and the combustion products in the mixing and reaction chamber towards an outlet opening of this chamber.

21. The streamlined body according to claim 14, wherein the combustion produces combustion products, and the streamlined body accelerates the flow of the fuel mixture and the combustion products in the mixing and reaction chamber towards an outlet opening of this chamber.

22. The streamlined body according to claim 15, wherein the combustion produces combustion products, and the streamlined body accelerates the flow of the fuel mixture and the combustion products in the mixing and reaction chamber towards an outlet opening of this chamber.

23. The streamlined body according to claim 1, wherein the streamlined body acts as a heat exchanger for preheating the fuel mixture.

24. The streamlined body according to claim 2, wherein the streamlined body acts as a heat exchanger for preheating the fuel mixture.

25. The use of a streamlined body according to claim 10, wherein the streamlined body acts as a heat exchanger for preheating the fuel mixture.

26. The use of a streamlined body according to claim 11, wherein the streamlined body acts as a heat exchanger for preheating the fuel mixture.

27. The use of a streamlined body according to claim 14, wherein the streamlined body acts as a heat exchanger for preheating the fuel mixture.

28. The use of a streamlined body according to claim 15, wherein the streamlined body acts as a heat exchanger for preheating the fuel mixture.

29. The use of a streamlined body according to claim 17, wherein the streamlined body acts as a heat exchanger for preheating the fuel mixture.

30. An apparatus for burning a fuel mixture, the apparatus comprising a mixing and reaction chamber and a streamlined body having a main axis and an outer surface, the streamlined body arranged with its main axis inside the chamber in the direction of flow, the outer surface of which being generated by rotating the top surface side of an aeroplane wing profile about its profile chord.

31. The apparatus according to claim 30, wherein the burning has an associated flow direction and wherein the streamlined body arranged with its main axis inside the chamber in the direction of flow.

32. The apparatus according to claim 30, wherein the mixing and reaction chamber has a cylindrically shaped lower section, adjoining which is a conically tapering section adjacent to which is a head having a hyperboloid-like shape with a widening cross section, terminating in an outlet opening.

33. The apparatus according to claim 31, wherein the chamber has a main axis and the streamlined body is arranged with its main axis substantially on the main axis of the chamber.

34. The apparatus according to claim 31, wherein the position of the streamlined body may be selectively varied.

35. A method of influencing the flow dynamics of a fluid, comprising the step of providing a streamlined body at least partly corresponding to a symmetrically rotated airfoil.

36. The method according to claim 35, wherein the streamlined body acts as at least one of an impact member, a flow regulator or a heat exchanger.

37. The method according to claim 35, wherein the streamlined body evens and accelerates flows.

38. The method according to claim 35, further comprising providing a mixing and reaction chamber for burning a fuel, wherein the streamlined body is in the mixing and reaction chamber, and acts as at least one of an impact member, a flow regulator or a heat exchanger.

39. A combustion method comprising the steps of providing a mixing and reaction chamber, a flow of a fuel mixture and a streamlined body wherein the fuel mixture flowing into the mixing and reaction chamber is combusted, the streamlined body having a main axis and being arranged with its main axis inside the chamber in the direction of flow, wherein an outer surface of the streamlined body is generated by rotating a top surface side of an aeroplane wing profile about its profile chord.

40. The method according to claim 39, wherein the geometry of the streamlined body is variable.

41. The method according to claim 39, wherein the streamlined body produces a laminar flow.

42. The method according to claim 39, wherein the streamlined body is placed with its main axis in the direction of flow in an otherwise free cross section of flow in order to produce a suction effect in the direction of flow.

43. The method according to claim 39, wherein the streamlined body has a rear stagnation point, and the rear stagnation point is downstream.

44. The method according to claim 39, wherein the fuel mixture comprises at least one of gaseous, liquid and solid constituents, and wherein the streamlined body provides an impact surface for the fuel mixture and provides for at least one of separation, distribution, atomisation and comminution of the fuel mixture, and at least one of slowing down constituents of the fuel mixture, increasing the residence time of the constituents, mixing the constituents more thoroughly, accelerating the flow of the fuel mixture and preheating the fuel mixture.
